(19) United States
(12) Patent Application Publication
(10) Pub. No.: US 2007/0136205 A1
(43) Pub. Date: Jun. 14, 2007

(54) Digital rights management unit for a digital rights management system

(75) Inventor: Henrik Przybilla, Hamburg (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Phillips Electronics N.C.

(21) Appl. No.: 10/577,087

(22) PCT Filed: Dec. 21, 2004
(86) PCT No.: PCT/IB04/52163

§ 371 Date: Apr. 24, 2006

(30) Foreign Application Priority Data
Oct. 22, 2003 (EP) 03103902.7

(51) Int. Cl. G06Q 99/00

(52) U.S. Cl. 705/54

(57) ABSTRACT

The present invention relates to a DRM user unit (2) for interacting with DRM client units (3) and DRM server units (1) of a DRM system, said DRM client units (3) storing digital data objects (DDO) and said DRM server units (1) issuing digital rights objects (DRO) representing usage rights of associated digital data objects, said DRM user unit (2) comprising an authentication unit (21) and a rights storage unit (22) for the storage of said digital rights objects. According to the invention the authentication of a DRM client (31) is relocated to the DRM user unit (2) that is possessed by an end user. This has the advantage that now a digital rights objects is a personal license that can be used with more than one playback device/playback system while guaranteeing that no illegal copies in any form can be made of the purchased content. A service provider may now implement his own specific software routines in the DRM user unit (2) to authenticate the DRM client (31) running on the DRM client unit (3) of the user.

The present invention relates to a digital rights management (DRM) user unit for interacting with DRM client units and DRM server units of a DRM system, said DRM client units storing digital data objects and said DRM server units issuing digital rights objects representing usage rights of associated digital data objects.

The invention relates further to a DRM client unit, a DRM system and a DRM method. The application area of the invention is the distribution and the management of digital rights objects used for the representation of the permission of the use of digital data objects in digital rights managements systems.

Digital Rights Management (DRM) is used in consumer devices and PCs, the DRM client units (often also called target systems), to restrict the use of digital data in order to safeguard the interests of the content owners. For instance, the ability to copy the digital data can be restricted or the number of times the digital data can be used can be limited. In addition, other restrictions like expiration times of usage rights can be employed by DRM systems. DRM systems feature a wide variety of measures to prevent non-authorized use of digital data. One area of particular interest for the consumer electronics industry is the introduction of Digital Rights Objects (DRO) for digital data that is distributed electronically. The DRO is a digital file that represents the permission to use a specific Digital Data Object (DDO) and that contains all restrictions of the use of the DDO.

The DRO is used by a DRM client in the DRM client units to apply the rules and limits that the content owner stipulates for the use of the DDO. The security of the system depends exceptionally on the trustworthiness of the DRM clients. A conventional DRM system sets up a relationship between a DRO and one particular DRM client so that the DDO that is associated with the DRO can only be used by one particular DRM client. This represents a very severe restriction for the purchaser of the DRO: since the DRM client is located in one particular device (i.e. one particular DRM client unit or target system, such as one particular PC), the DRO can not be used with any other equipment.

US 2001/0029581 A1 discloses a system for providing rights controlled access to digital media comprises a server data processor and a client data processor connected by a communications network. The user data processor provides access to a data object in accordance with rules associated with the data object by the server data processor. The client data processor comprises a machine key device and a user key device. The machine key device is preferably an installed component of the client data processor that provides encryption, decryption, and authentication functionality for the client data processor. The user key device is preferably a removable, portable device that connects to the client data processor and provides encryption, decryption, and authentication functionality for the user. A method restricts the use of a data object to a particular user and a particular data processor through the use of additional layers of encryption. The method preferably comprises encrypting a data object such that the it can be decrypted by the machine key device, and further encrypting the data object such that it can be decrypted by the user key device. Another method restricts the use of a data object to a particular user and a particular data processor through the use of rules that require authentication of the machine key device and the user key device.

It is thus an object of the present invention to provide appropriate measures in a DRM system which overcome the above described limitation in known DRM systems where a DRO can only be used with one particular DRM client unit.

This object is achieved according to the present invention by the introduction of a DRM user unit as claimed in claim 1 for interacting with DRM client units and DRM server units of a DRM system, said DRM client units storing digital data objects and said DRM server units issuing digital rights objects representing usage rights of associated digital data objects, comprising:

an authentication unit for authentication of the DRM user unit to a DRM server unit and for authentication of a DRM client unit to the DRM user unit, and

a rights storage unit for storing digital rights objects received from a DRM server unit, wherein said digital rights objects can be accessed by an authenticated DRM client unit to get usage rights for the usage of an associated digital data object stored on said DRM client unit.

The invention is based on the idea to relocate the authentication of a DRM client to a unit that is possessed by an end user. This unit is called a DRM user unit. The fact that a user based unit is performing the authentication of the DRM client bears the advantage that now a digital rights objects is a personal license that can be used with more than one playback device/playback system while guaranteeing that no illegal copies in any form can be made of the purchased content. A service provider may now implement his own specific software routines in the DRM user unit to authenticate the DRM client running on the DRM client unit of the user.

According to the invention the DRM user unit is the keeper of the DROs that a particular user posses. By use of a handshake scheme between the DRM server of a supplier of DROs and the DRM user unit, the DRM user unit authenticates itself to the DRM server. Further, by use of another handshake scheme between the DRM user unit and the DRM client of a DRM client unit the DRM client authenticates to the DRM user unit.

Thus, DRM administration functionality is set-up in the DRM user unit, which is preferably a portable unit. The DRM user unit is a functional unit that represents a trusted and certified counterpart of a server application that issues digital rights objects. The DRM user unit is adapted for storing the DROs and for authenticating the DRM clients of DRM client units. On request, the DRM user unit enables a trustworthy DRM client to use the DDO that is associated with the DRO stored in the DRM user unit. Before the DRM client is enabled to use the DDO, the DRM client preferably has to successfully authenticate itself to the DRM user unit.

The DRM user unit is an extension of the DRM server application, while this extension is running in the domain of the consumer. The storage of the data and algorithms in the DRM user unit is preferably done in a secured IC. The secured IC is protected against unauthorized read-out and manipulation of the stored data and algorithms. Secured ICs that are suited for DRM user units are e.g. smart card controller.

The present invention also relates to a DRM client unit for use in a DRM system, as claimed in claim 8, comprising:

a data storage unit for storing digital data objects,

an authentication unit for authentication of the DRM client unit to a DRM user unit, and

a rights interface for requesting access to a digital rights object associated with a digital data object stored in said data storage unit after authentication to a DRM user unit to get usage rights for the usage of said associated digital data object.

Further, the present invention relates to a DRM system as claimed in claim 9, comprising:

DRM client units for storing digital data objects,

DRM server units for issuing digital rights objects representing usage rights of associated digital data objects, and

DRM user units for interacting with said DRM client units and said DRM server units comprising:

an authentication unit for authentication of the DRM user unit to a DRM server unit and for authentication of a DRM client unit to the DRM user unit, and

a rights storage unit for storing digital rights objects received from a DRM server unit, wherein said digital rights objects can be accessed by an authenticated DRM client unit to get usage rights for the usage of an associated digital data object stored on said DRM client unit.

Still further, the present invention relates to a DRM method for use in a DRM system, as claimed in claim 10, said method comprising the steps of:

authentication of a DRM user unit to a DRM server unit,

transfer of a requested digital rights object from said DRM server unit to said DRM user unit after successful authentication,

authentication of a DRM client unit to said DRM user unit, and

transfer of usage rights from said DRM user unit to said DRM client unit after successful authentication for the usage of an associated digital data object stored on said DRM client unit.

Preferred embodiments of the invention are defined in the dependent claims. In a preferred embodiment the DRM user unit further comprises a rights interface unit for receiving digital rights objects from a DRM server unit to which the DRM user unit has authenticated and for granting usage rights for the use of a digital data object stored on an authenticated DRM client unit and associated with a digital rights object stored in said rights storage unit. In this embodiment, the DRM user unit is able to download and manage the DROs by itself. Specifically for the download and the management of the DROs the DRM user unit does not need to be connected to another device, for instance a DRM client unit, than could handle the input and output of DROs. However, in an alternative embodiment of the DRM user unit, no such rights interface is provided.

In a another embodiment the DRM user unit further comprises a revocation list storage unit for storing a revocation list of DRM client units, said revocation list being checked by said authentication unit during authentication of a DRM client unit. Thus, the DRM user unit can check during authentication of a DRM client unit if the DRM client is a valid client or not, and can restrict the access of particular or all DROs stored on the DRM client, if the DRM client is listed in the revocation list.

The data and algorithms in the DRM user unit can be updated during a connection between the DRM user unit and the DRM server of the service provider. This update procedure is preferably protected by cryptographic keys to ensure that only authorised instances are able to carry out changes of the data and algorithms of the DRM user unit. If the DRM user unit is represented by a smart card or uses a smart card IC as authentication unit, the additional smart card security measures ensure that no illicit access to the DRM user unit can be made.

The DRM user unit can be implemented by any portable electronic unit that contains a secure storage unit and processing unit for authentication. Advantageous implementations are a smart card, a PCMCIA card or a mobile terminal, such as a mobile audio and/or video player, a mobile phone or a PDA.

In addition, the DRM user unit can also be configured to function with -the same restrictions like the currently known DRM systems. In this case only a particular playback device, an assembly of functionally dependent playback devices or a limited number of playback devices or groups of functionally dependent playback devices can use the digital data object (DDO). Therefore, the digital rights objects include an access information which DRM client units shall get access to a digital rights objects, said access information being checked by the DRM user unit after authentication of a DRM client requesting access to said digital rights object. The limited number of supported DRM clients can, for instance, be determined by the DRM server prior to issuing the DRO to the DRM user unit. In this way the DRM system is flexible to support different operation schemes as defined by the issuer of the digital rights objects.

As an additional feature, backup copies of DROs can be supported. For this feature the DRM user unit can be formed as a unit that has an additional (portable) memory unit inserted. The core information of the main storage unit is backed up in the inserted memory unit. In case the main memory of the DRM user unit is damaged, all information can still be retrieved from the additional memory unit. The additional memory unit can be formed, e.g., by a smart card. While the information in the additional memory is sufficient to determine the rights in the DRM user unit, it is preferably not sufficient to set up a working second DRM user unit with the same rights.

In case that backup copies of the DROs are present, the DRM system can be set up to allow the usage of a DRO in a DRM user unit only, if the memory unit that contains the copy of the DRO is present in the DRM user unit. With this scheme, a backup copy of a DRO featuring internal states is possible. Internal states in a DRO are used to implement, e.g., a limited number of uses of the DDO.

Since the DRM user unit can be stored separately from the additional memory unit, this embodiment can also be used for the prevention of theft of the DROs. If one of the two units that store the DROs are stolen, that unit can not be used. The legitimate owner of the DRO did not transfer a DRO voluntarily and hence it is possible to redistribute an initial DRO to the legitimate owner.

DROs can be either transferable or non-transferable. A transferable DRO can be used with more than one DRM client. The usage rights can optionally be restricted to a fixed set of DRM clients. In contrast, a non-transferable DRO can only be used with one specific DRM client. Thus, according to an aspect of the invention, the digital rights objects include an transfer indicator indicating if a digital rights object is transferable to all DRM client units or not, and the authentication unit is adapted for authenticating the DRM client unit requesting access to a non-transferable digital rights object to the DRM server unit.

The invention will now be explained in more detail with reference to the drawings in which

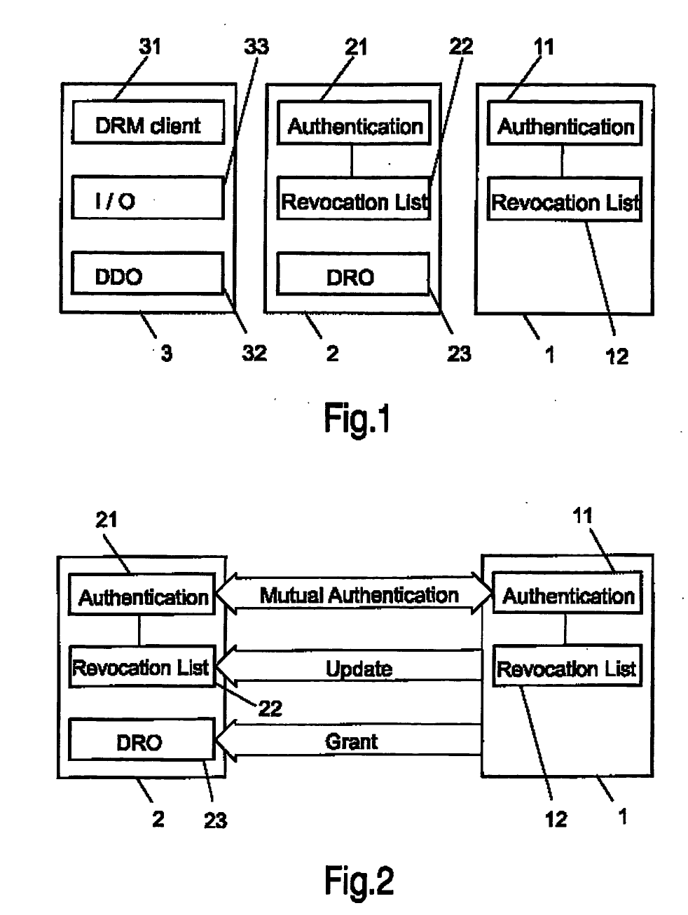

FIG. 1 shows the layout of a DRM system according to the invention,

FIG. 2 shows the interoperation of a DRM user unit and a DRM server unit,

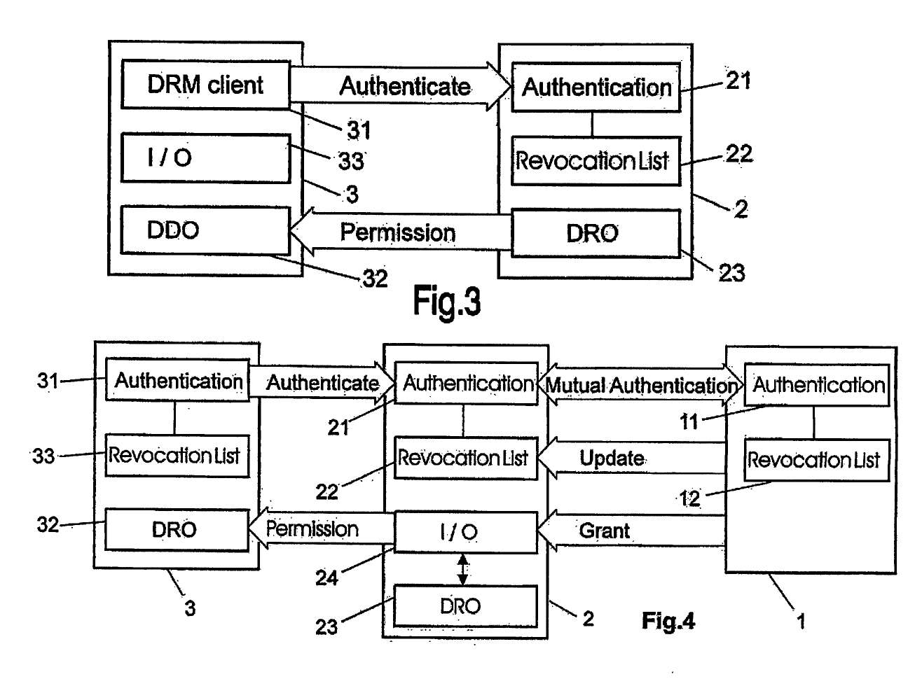

FIG. 3 shows the interoperation of a DRM user unit and a DRM client unit,

FIG. 4 shows the layout of a DRM system according to the invention with a slightly different interoperation scheme, and

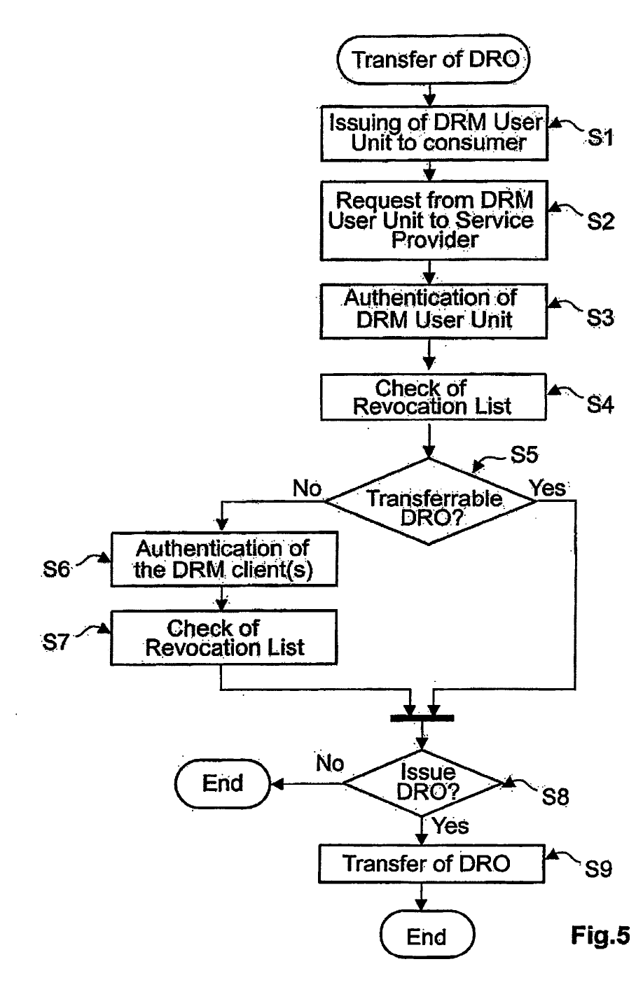

FIG. 5 shows a flow-chart of a DRM method according to the invention.

The currently known systems for a digital rights management feature three main functional entities: a DRM client in a DRM client unit at the customer side, a DRM server at a service provider, which issues the DROs and a content provider that issues the DDOs. The disadvantage of this system from the user perspective is that the DRO issued by the DRM server can be used only by one particular DRM client, and in the presently known systems that the DRM client is assigned to one particular electronic device or to a group of electronic devices that are functionally dependent on each other. In other words, it is an intrinsic feature of the presently known DRM systems, that the DRO that a customer purchases can not be used like a personal license to use the related content on the playback devices of choice. Hence, the content can only be played back on a fixed device, regardless who possess this device. The reason for this is to guarantee that each DRO represents exactly one permission to use the DDO. This guarantees that no “copies” in any form can be made of the purchased content. To assure this, a DRM client is authenticated before, a DRO is issued to the DRM client. The authentication of the DRM client includes the checking a revocation list that has registered devices that are reported broken or possibly broken. Based on the authentication data of the DRM client and possible entries in the revocation list, a DRO is issued to the DRM client or the issuing of the DRO to the DRM client is denied.

The system set-up of a DRM system featuring a DRM user unit as proposed by the present invention is shown in FIG. 1. The DRM system consists of:

A DRM server unit 1: this server manages and controls the transfer of digital rights objects into the user domain. The terms and conditions for the sale and use of the DROs are set by the content provider that owns the rights on the digital data objects. The content provider is not considered any further in this document and is not shown in the figure. The DRM server uses an authentication algorithm in an authentication unit 11 to guarantee the identity of the receiver of DROs and a revocation list stored in a revocation list storage 12 to check the integrity of the receiver of DROs.

A DRM user unit 2: this unit stores the DROs in the user domain in a rights storage unit 23. On the basis of a DRO the DRM user unit 2 controls the use of a digital data object by the DRM client unit 3. For this purpose, the DRM user unit 2 contains an authentication unit 21 for processing an authentication algorithm and a revocation list storage 22. Both elements are provided and maintained by the operator of the DRM server unit 1. If a DRO is released into the user domain, this DRO is stored in the rights storage unit 23.

A DRM client unit 3: this unit runs a DRM client 31 and uses the DDOs stored in a data storage unit 32 on the basis of the associated DRO that is stored in the DRM user unit 2. In order to get a permission to use the DDO, the DRM client 31 has to authenticate itself to the DRM user unit 2 and has to access or request a DRO therefrom by use of a rights interface 33.

The operation of the DRM system can be seen from FIGS. 2 and 3. In FIG. 2 the transfer of a DRO from the DRM sever unit 1 to the DRM user unit 2 is shown. In order for the DRM user unit 2 to obtain a DRO and for the DRM server unit 1 to possibly update the authentication algorithm and the revocation list, a mutual authentication between the DRM user unit 2 and the DRM server unit 1 has to be traded out. Especially the DRM server unit 1 checks if the DRM user unit 2 is recorded in the revocation list stored in the revocation list storage 12. After a successful authentication, several actions are possible, such as grant of digital rights object, update of authentication algorithm, or update of the revocation list stored in the revocation list storage 22 of the DRM user unit 2.

After the transactions between the DRM server unit 1 and the DRM user unit 2, the DRM user unit 2 contains the current version of the authentication algorithm and revocation list and a valid set of digital rights objects. The use of a DRO is managed by the DRM user unit 2 autonomously.

In FIG. 3 the use of a digital rights object is shown. The key functionality of the DRM user unit 2 is that it can grant the permission to use a specific DDO to different DRM client units 3, but preferably not to more than one at a time. As a first step the DRM client 31 of the DRM client unit 3 has to authenticate itself to the DRM user unit 2. The DRM user unit 2 checks with e.g. a challenge-response handshake if the DRM client 31 of the DRM client unit 3 is a valid client. In a next step the revocation list is checked whether the specific DRM client 31 is listed there. After a successful authentication of the DRM client unit 3, a permission of the use of a DDO can be granted to the DRM client unit 3, depending on the restrictions and limitations of the DRO.

An alternative operation of the DRM system is required in the case that the digital rights objects are non-transferable. In this case the DRO is bound not only to a specific DRM user unit 3, but also to a specific DRM client 31. The related operation scheme is depicted in FIG. 4. The difference to the scheme shown in FIG. 3 is that not only a mutual authentication of the DRM user unit 2 and the DRM server unit 1 is required, but that also the DRM client 31 of the DRM client unit 3 has to authenticate itself to the DRM server unit 1 through the DRM user unit 2. The use of the DRO that is issued afterwards by the DRM server unit 1 to the DRM user unit 2 is restricted to the one DRM client 31 that has authenticated itself successfully to the DRM server unit 1.

Further, an additional rights interface 24 of the DRM user unit 2 is shown in FIG. 4 which serves for receiving digital rights objects from the DRM server unit 1 to which the DRM user unit 2 has authenticated and for granting usage rights for the use of a digital data object stored on an authenticated DRM client unit 3.

A flow chart of an embodiment of a DRM method according to the invention for issuing of a DRO to a DRM client is illustrated in FIG. 5. In step S1 the DRM user unit 2 is issued to the consumer. In step S2 the consumer uses the DRM user unit 2 to issue a request for a DRO to a service provider, in particular to the DRM server unit 1 of the service provider. The service provider checks the identity of the DRM user unit 2 in step S3 and a revocation list in step S4.

If the requested DRO is a transferable DRO, then it continues with step S8. In this step the decision is made whether or not the DRO is issued to the DRM user unit 2. If a negative decision is made, the scheme ends; in case a positive decision is made the scheme continues with step S9 where the DRO is transferred to the DRM user unit 2.

In case that the requested DRO is non-transferable, the security level of the transaction is increased: The DRM user unit 2 has to provide one fixed identity of an DRM client 31 to the service provider. This identity of the DRM client 31 is checked by the service provider in the steps S6. In step S7 a revocation list is checked with respect to the DRM client 31. After the checks the decision is made whether the DRO is going to be submitted to the DRM user unit 2 and the DRM client unit 3. Then the scheme continues in case of a positive decision with the step S9 and ends afterwards.

The DRM user unit can be implemented by any portable electronic unit that contains a secure storage and a processing unit (for authentication) and, preferably, a suitable interface. Two instances of the DRM user unit are described here in more detail.

The DRM user unit can be represented by a smart card. In this case the DRM user unit does not have an own user interface, so for any operation that requires a user interaction, the smart card has to be linked to a device that can handle the user I/O. Primarily there are three different devices that will be used as I/O devices for a smart card that functions as DRM user unit:

1) The DRM client unit: In this case the DRM user unit gets the user I/O through the interfaces of the playback equipment. The DRM user unit may be used by the DRM client unit for e.g. the playback of a DDO, but also the user may download additional digital rights objects through the DRM client unit in case the DRM client unit has a suitable network connection.

2) A mobile terminal: In this case the mobile terminal, e.g. a mobile phone, can provide all elements that are needed in addition to the smart card for a complete system in the user domain. The terminal has its own user interface, a network connection for obtaining additional digital rights objects, and also a DRM client can be present in case the terminal can function as an output device for A/V data.

3) A stationary terminal at a prominent location like a concert hall, a library, a record shop, a filling station, a supermarket or other places. This kind of terminal is employed by the user for the download of additional DRO.

A smart card as a DRM user unit can interact with a terminal or the DRM client unit via a contact or a contactless interface. The DRM user unit can also be a PCMCIA Card containing a smart card controller. In the PCMCIA card an additional small form factor smart card can be inserted.

The DRM user unit can also be represented by a mobile terminal. In this case the DRM user unit contains all necessary interfaces to download and manage the DRO. In addition, the mobile terminal can function as a DRM client unit, e.g. as a MP3 player or an MPEG4 video playback device. The mobile terminal must contain a secure processing and storage unit in order to guarantee the integrity of the DRM system. The interfacing between the mobile terminal as the DRM user unit and a DRM client unit will preferably be a contactless interface like e.g. ISO 14443 or NFC (near field communication).

The following usage scenarios outline the possible use of a DRM user unit mostly on the base of an NFC enabled mobile terminal. The handling of the DRO can be implemented on smart cards as well, but the use of an NFC device brings additional functionality to the system.

In a first usage scenario the consumer goes to a record shop to buy records. In the store he enjoys a sample track of a particular recording of music. The consumer decides to buy this recording. Along with conventional CDs and SACDs the record store offers as well to buy digital rights objects for the selected recordings. Since this option is offered at ⅔ of the price of the CD, the consumer chooses to get a DRO for the selected recording. The consumer goes to a terminal at the record store and puts his mobile phone based DRM user unit in the interaction area of the contactless reader of the terminal. The mobile phone and the terminal use their NFC interfaces for the subsequent transactions. The consumer selects the desired recording and pays the DRO with the credit card applet that is also stored on his mobile terminal. In addition the consumer is offered to download a compressed version of the recording he just bought as a digital data object into his mobile phone at no additional cost. The interface for this download can be e.g. 802.11, FastNFC or USB. The DDO of the recording is protected and can only be used with a suitable DRO. At home the consumer downloads a larger file with a high definition version of the same recording. Both DDOs can be used with the same DRO. The consumer now possesses a transferable digital rights object of the recording, so he can enjoy it in a compressed version on his mobile phone as well as in a high quality representation on his stereo set at home.

In a further usage scenario the consumer watches a broadcast of an impressing concert at home. At the end of the performance the broadcaster shows an advertisement, stating that for a very special price a non-transferable limited DRO of the performance with 5 presentation times can be purchased online. The consumer wants to take advantage of this special offer and connects his stereo system via the NFC interface and GSM connection of his mobile phone to the DRM server of the provider. The DRM server authenticates both, the DRM user unit (mobile terminal) as well as the DRM client (stereo set). After the successful authentication and a payment via the VISA applet of the mobile phone, the DRO for the concert is transferred to the mobile phone. This particular DRO can be used only in conjunction with the specific stereo set (non-transferable DRO).

In another usage scenario the consumer is on a business trip. His rental car is equipped with a generic cradle for mobile phones, this cradle also features an NFC interface to the car stereo system. The consumer puts his mobile terminal into the cradle for a hands free operation of the phone and to enable the car stereo set to use the digital rights objects stored in his mobile phone. After selection of a particular recording the car stereo system retrieves the recording as a stream of compressed data from a network server. The car stereo system decompresses and plays back the music. The service to receive compressed DDOs from a network server is part of the consumer's mobile phone subscriber package.

During the business trip the consumer stays in a hotel room with a Pay-TV system. Fortunately the system features an open interface to use personal subscriptions during the stay in the hotel. Knowing that, the consumer took his subscription card, the DRM user unit, for watching a particular film along and can now watch this film as he would do at home.

In a further usage scenario the consumer wants to be able to play back a particular recording at realistic levels, but his current equipment is not capable of delivering this without distortions, so he decides to upgrade his system. The consumer goes to a shop for a test session, and after hearing some sample tracks he requests to hear a special recording. The shop does not own the recording, but by the use of the high speed connection of the shop, a high resolution DDO of the recording can be downloaded into the storage device of the equipment of the store. The particular DDO can be played back at the shop with the use of the DRM user unit that the consumer possesses.

According to the present invention the authentication of a DRM client is relocated to the DRM user unit that is possessed by an end user. This has the advantage that now a digital rights objects is a personal license that can be used with more than one playback device/playback system while guaranteeing that no illegal copies in any form can be made of the purchased content. A service provider may now implement his own specific software routines in the DRM user unit to authenticate the DRM client running on the DRM client unit of the user.

1. Digital rights management user unit for interacting with DRM client units and DRM server units of a DRM system, said DRM client units storing digital data objects and said DRM server units issuing digital rights objects representing usage rights of associated digital data objects, comprising:
an authentication unit for authentication of the DRM user unit to a DRM server unit and for authentication of a DRM client unit to the DRM user unit and
a rights storage unit for storing digital rights objects received from a DRM server unit wherein said digital rights objects can be accessed by an authenticated DRM client unit to get usage rights for the usage of an associated digital data object stored on said DRM client unit

2. DRM user unit as claimed in claim 1,
further comprising:
a rights interface unit for receiving digital rights objects from a DRM server unit to which the DRM user unit has authenticated and for granting usage rights for the use of a digital data object stored on an authenticated DRM client unit and associated with a digital rights object stored in said rights storage unit

3. DRM user unit as claimed in claim 1,
further comprising:
a revocation list storage unit for storing a revocation list of DRM client units said revocation list being checked by said authentication unit during authentication of a DRM client unit

4. DRM user unit as claimed in claim 1,
wherein said DRM user unit is a portable electronic device, in particular a smart card, a PCMCIA card or a mobile terminal, such as a mobile audio and/or video player, a mobile phone or a PDA.

5. DRM user unit as claimed in claim 1,
wherein said digital rights objects include an access information which DRM client units shall get access to a digital rights objects, said access information being checked by the DRM user unit after authentication of a DRM client requesting access to said digital rights object.

6. DRM user unit as claimed in claim 1,
further comprising:
a portable memory unit for storing at least part of the digital rights objects or a copy of the digital rights objects stored in said rights storage unit the presence of said portable memory unit being checked before an access to digital rights objects is granted.

7. DRM user unit as claimed in claim 1,
wherein said digital rights objects include an transfer indicator indicating if a digital rights object is transferable to all DRM client units or not, and
wherein said authentication unit is adapted for authenticating the DRM client unit requesting access to a non-transferable digital rights object to the DRM server unit

8. Digital rights management client unit for use in a DRM system, said DRM system comprising DRM server units issuing digital rights objects representing usage rights of associated digital data objects and DRM user units for interacting with said DRM client units and said DRM server units comprising:
a data storage unit for storing digital data objects,
an authentication unit for authentication of the DRM client unit to a DRM user unit and
a rights interface for requesting access to a digital rights object associated with a digital data object stored in said data storage unit after authentication to a DRM user. unit to get usage rights for the usage of said associated digital data object.

9. Digital rights management system
comprising:
DRM client units for storing digital data objects
DRM server units for issuing digital rights objects representing usage rights of associated digital data objects, and
DRM user units for interacting with said DRM client units and said DRM server units comprising:
an authentication unit for authentication of the DRM user unit to a DRM server unit and for authentication of a DRM client unit to the DRM user unit and
a rights storage unit for storing digital rights objects received from a DRM server unit wherein said digital rights objects can be accessed by an authenticated DRM client unit to get usage rights for the usage of an associated digital data object stored on said DRM client unit

10. Digital rights management method for use in a DRM system, said DRM system comprising DRM client units for storing digital data objects DRM server units for issuing digital rights objects representing usage rights of associated digital data objects and DRM user units for interacting with said DRM client units and said DRM server units said method comprising the steps of:
authentication of a DRM user unit to a DRM server unit
transfer of a requested digital rights object from said DRM server unit to said DRM user unit after successful authentication,
authentication of a DRM client unit to said DRM user unit, and
transfer of usage rights from said DRM user unit to said DRM client unit after successful authentication for the usage of an associated digital data object stored on said DRM client unit
